(19) United States
(12) Patent Application Publication
(10) Pub. No.: US 2004/0027535 A1
(43) Pub. Date: Feb. 12, 2004

(54) Ocular device

(76) Inventor: Einar Th. Einarsson, West Sussex (GB)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/332,361

(22) PCT Filed: Jan. 19, 2001
(86) PCT No.: PCT/IB01/00053

(30) Foreign Application Priority Data
Jan. 21, 2000 (GB) 0001285.6

(51) Int. Cl. G02C 1/02

(52) U.S. Cl. 351/110

(57) ABSTRACT

The ocular shading device has a frame (1) with a front piece (2) for supporting two opaque eye shading elements (3) and two hinged side pieces (4) adapted to grip a wearer's temple, at which they have down- and in-turned ends (41) as in a conventional pair of spectacles. The three frame pieces are of injection moulded acetal plastics material; whilst the vision assistance elements are of moulded polypropylene material. The front piece has back-turned ends (21), which are curved at (22) and extend straight back (23) from upper and lower hinge apertures (24). The straight extensions (23) limit the pivotal movements of the side pieces (4) in the use position. At the hinge apertures, the extensions are channel shaped, with the channel (25) being open inwards. The extensions have angled back edges (26), defining points (26′) with the tops of the extensions.

The present invention relates to an ocular device, that is a device for assisting vision, in particular an ocular device of the type having a frame with a front piece for supporting two vision assistance elements and two hinged side pieces adapted to grip a wearer's temple.

One common form of ocular device of this type is a pair of spectacles, in which the vision assistance elements are lenses for correcting defects in the wearer's eyesight. Another common ocular device is a pair of dark glasses in which the vision assistance elements are plain lens which are tinted to restrict light transmission.

In my U.S. Pat. No. 5,835,182, I have proposed another form of ocular device, in which opaque eye-shading vision assistance elements are mounted on the front piece above the line of vision but in a position so as to shade the eyes from direct sun light in the manner of a cap.

The object of the present invention is to provide an ocular device of any of the three mentioned types, but in particular the third, having an improved frame.

In a conventional spectacle frame, the side pieces are hinged to the front piece by hinges—usually of metal—having pivot axes set in from the line of the side pieces and abutments between the side pieces and the front piece spaced directly side-ways from the pivot axes. Whilst such an arrangement is satisfactory for metal hinges, it is difficult to execute in plastics materials, principally because the restricted lateral width of the hinge implies high forces at the hinge pin in order to generate the couple necessary to cause the side pieces to grip the wearer's temple. These forces are generally too high for a plastic hinge to resist.

According to the present invention there is provided an ocular device having a frame with a front piece for supporting two vision assistance elements and two hinged side pieces adapted to grip a wearer's temple, in which:

the front piece and the two side pieces are of injection moulded plastics material;

respective hinges between the front piece and the side pieces are comprised entirely of features moulded into the front and side pieces;

the front piece has extensions backwards from the hinge axis for limiting the pivotal movement of the side pieces in their use position.

The backwards extensions cause the temple gripping couple to be generated over the length of the extension as opposed to the width of the frame from the pin axis is outwards. In the preferred embodiment, the ratio of the extension length to the hinge width outwards of the pin is of the order of 5 to 1. However, it is believed that the ratio could be reduced to the order of 3 to 1 or indeed increased to the order of 8 to 1.

Preferably the extension at each side includes a rearwards extension of a groove in the inside of back-turned ends of the front piece, top and bottom lips of the groove having hinge apertures; and each side piece has a front tang extending into the groove and having top and bottom hinge pins for engaging in the hinge apertures. Conveniently, the tang has a slot between the pins allowing them to be sprung together for fitting into the apertures. In the preferred embodiment, the rear edges of the extensions are angled with respect to the hinge axis, preferably forming points with the top of the extensions.

The hinge axis can be inclined for and aft, with the upper pin being behind the lower pin, in order to cause the angled end of the side pieces to incline forwards when closed to the front piece. Typically the inclination is of the order of 5°. Additionally, hinge axis can be inclined laterally, with the upper pin being outwards of the lower pin, in order to cause the side pieces to cross when folded together.

In accordance with a preferred feature of the frame, the front piece has a central portion with a regular cross-section and to which an adjustable nose piece is clipped. In the preferred embodiment, the nose piece has a central stem and a dependent, forked nose abuttal. In a variant, the nose piece is formed integrally with the front piece.

In the preferred embodiment, the vision assistance elements are opaque eye shading elements extending forwards and slightly downwards. At each element, the front piece is arched to an arched transverse shape of the shading elements. The latter are clipped to the frame at opposite sides of their arches to provide them with their arched shape.

The shading elements are preferably laminar, with integrally moulded ribs at the rear edge to provide comfortable abutment against the wearer's eyebrows. Usually, the rear edge will be contoured to match the wearer's bone structure at the eyebrow. Surprisingly it has been found that this structure has a similar curvature for many individuals.

In the preferred embodiment, the front piece has front and rear lips at either end of each arch for clipping engagement over the vision assistance elements, the vision assistance elements having lateral notches for engagement with the front piece at the lips, the lips being generally aligned with the ends of the arches. Conveniently, the front piece lips provide the upper bounds of grooves in which the notched vision assistance elements engage.

Preferably the front piece and/or the side pieces are of acetal polymer. It has been found—surprisingly—that if the frame is too wide/narrow for an individual, one or more of the pieces can be given a permanent set to alter the width by bending and holding it for the order of five seconds at room temperature.

To help understanding of the invention, a specific embodiment thereof will now be described with reference to the accompanying drawings, in which:

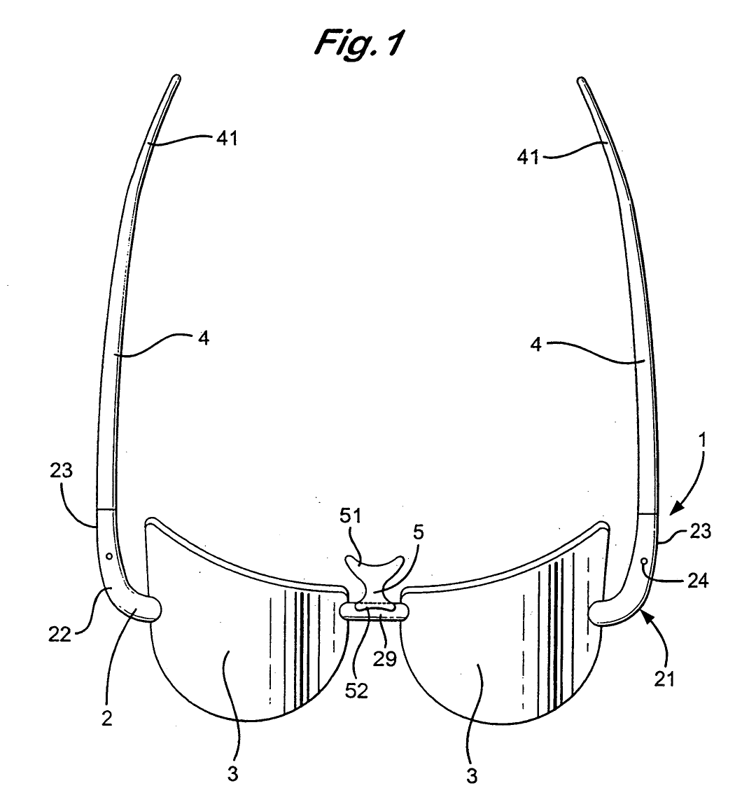

FIG. 1 is a plan view of a ocular shading device according to the invention;

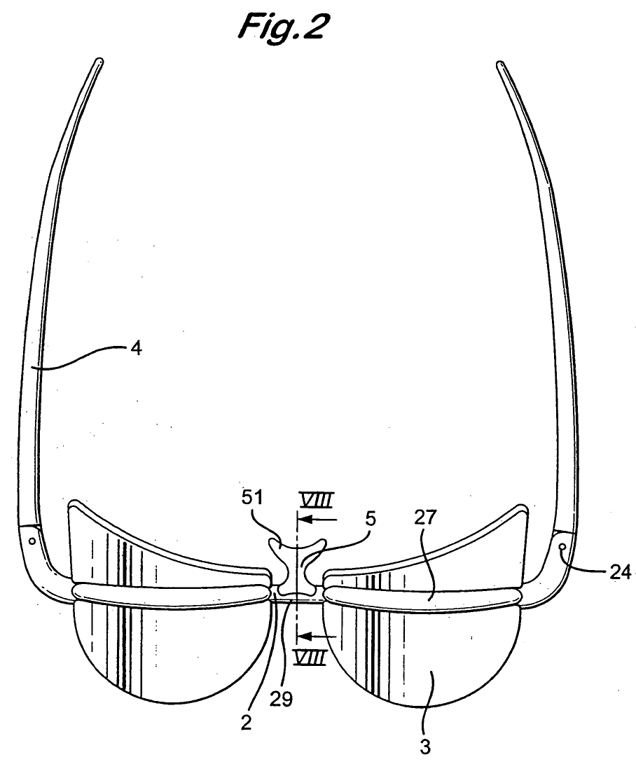

FIG. 2 is an underneath view of the device of FIG. 1;

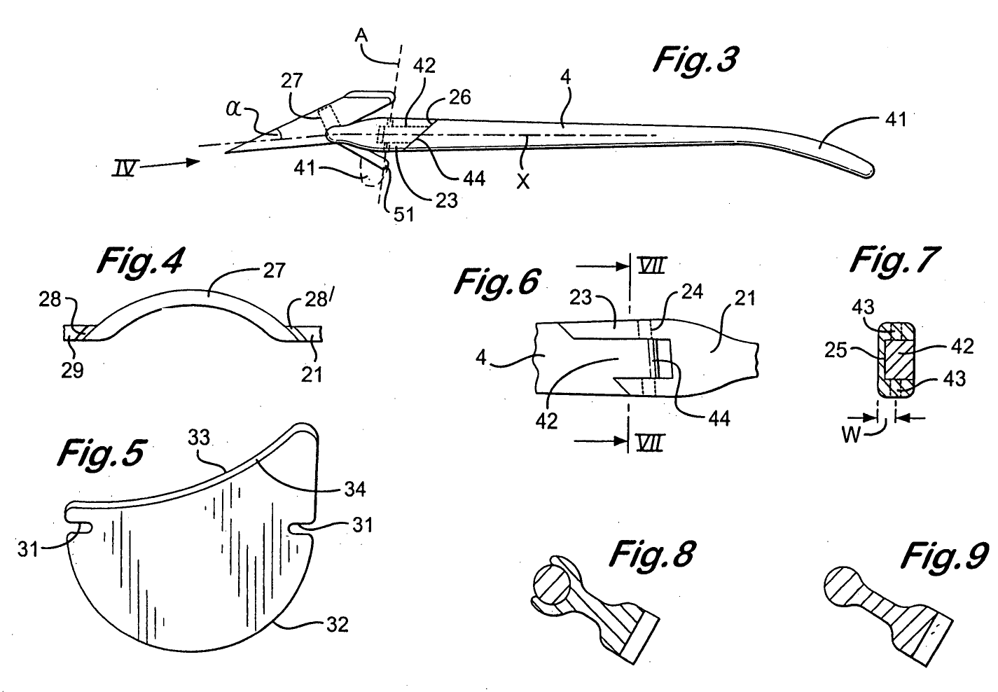

FIG. 3 is a side view of the device;

FIG. 4 is a scrap front view in the direction of Arrow IV in FIG. 3, with the shading element removed;

FIG. 5 is a plan view of the shading element;

FIG. 6 is an inside view of a hinge between the front piece and a side piece of the device;

FIG. 7 is a cross-sectional view on the line VII-VII in FIG. 6;

FIG. 8 is a cross-sectional side view on the line VIII-VIII in FIG. 2 of the front piece and the nose piece;

FIG. 9 is a similar view of a variant, in which the front piece and the nose piece are integrally moulded.

The ocular shading device shown in FIG. 1 has a frame 1 with a front piece 2 for supporting two opaque eye shading elements 3 and two hinged side pieces 4 adapted to grip a wearer's temple, at which they have down- and in-turned ends 41 as in a conventional pair of spectacles. The three frame pieces are of injection moulded acetal plastics material; whilst the vision assistance elements are of moulded polypropylene material.

The front piece has back-turned ends 21, which are curved at 22 and extend straight back 23 from upper and lower hinge apertures 24. The straight extensions 23 limit the pivotal movement of the side pieces 4 in their use position as will be described. At the hinge apertures, the extensions are channel shaped, with the channel 25 being open inwards. The extensions have angled back edges 26, defining points 26′ with the tops of the extensions.

The front of the side pieces have tangs 42 complementary to the shape of the channels 25. The very front of each tang carries upper and lower pins 43 and has a split 44 therebetween. This enables the pins 43 to be deflected towards each other for fitting into the apertures 24. Where the tangs meet the side members proper, the latter swell out with an angled edge 44 complementary to the edge 26.

In use, it will be understood that the couple exerted on the side pieces by their resilience in abutment with the user's temples is reacted at the hinge by equal and opposite forces exerted at the pins and the back edge of the channel. In so far as the back edge is angled, the force will be reacted predominantly at the top of back edge. The pin and edge forces are significantly spaced, which causes them to be significantly less than they would be if they were not spaced by the effective length of the extensions. Typically this is of the order of 10 mm (at the top of the groove). This causes the force tending to burst the pins out of the apertures to be low enough for them to remain in the apertures and for the frame to retain its integrity. The width W of the extension from its outer surface to the aperture/pin centre is typically 2 mm.

The hinge axis A is inclined with respect to the general direction X of the side pieces, with the upper pin being behind the lower pin, in order to cause the angled ends 41 of the side pieces to incline forwards when closed to the front piece, as shown in FIG. 3 by the dotted position of the end. Typically the inclination is 5°, i.e. the axis A is set at 85° to the direction X.

Inwards of the curves 22, the front piece is arched 27 in front of each eye brow. The arches are inclined slightly forwards as can be seen in FIG. 3. This inclination is at right angle to the inclination α of the eye shading elements 3, the inclination α being of the order of 20°. At each end of the arches there are provided grooves 28 with upper bounding lips 28′, into which the elements 3 can clip via small notches 31. The shading elements have semi-circularly curved front edges 32 and asymmetrically curved rear edges 33. These have integrally moulded ribs 34 to provide comfortable abutment against the wearer's eyebrows.

Between arches 27, the front piece has a straight central portion 29 of circular cross-section. A nose piece 5 is clipped to the central portion. It has a stem 51, a forked rear 52, which is sized to fit the bridge of a nose. The front of the nose piece has a slightly over-hung transverse slot 53, which clips onto the central portion. The nose piece can be pivoted up or down with respect to the front piece, so that the ocular device can be adjusted in its position on the wearer's face.

As can be seen in seen in FIG. 3, the ocular shading device folds into a compact shape, in the manner of a pair of spectacles, despite the fact that in spectacles the lens extend up and down, whilst in the ocular shading device the shading elements are more horizontal than vertical. This is largely attributable to the inclination of the hinge axis A. Further, the axes can be slightly angled when view from behind, to cause the ends 41 to be lifted to the level of the front piece when closed as well as being inclined forwards.

The invention is not intended to be restricted to the details of the above described embodiment. For instance, instead of the nose piece being a separate piece, it 105 can be integrally moulded with the front piece, as shown in the FIG. 9.

1. An ocular device having a frame with a front piece for supporting two vision assistance elements and two hinged side pieces adapted to grip a wearer's temple, in which:
the front piece and the two side pieces are of injection moulded plastics material;
respective hinges between the front piece and the side pieces are comprised entirely of features moulded into the front and side pieces;
the front piece has extensions backwards from the hinge axis for limiting the pivotal movement of the side pieces in their use position.

2. An ocular device as claimed in claim 1, wherein the backwards extensions cause temple gripping couple to be generated over the length of the extension.

3. An ocular device as claimed in claim 2, wherein the ratio of the extension length to the hinge width outwards of the pin is between the order of 3 to 1 and the order of 8 to 1.

4. An ocular device as claimed in claim 3, wherein the ratio of the extension length to the hinge width outwards of the pin is of the order of 5 to 1.

5. An ocular device as claimed in any preceding claim, wherein the extension at each side includes a rearwards extension of a groove in the inside of back-turned ends of the front piece, top and bottom lips of the groove having hinge apertures; and each side piece has a front tang extending into the groove and having top and bottom hinge pins for engaging in the hinge apertures.

6. An ocular device as claimed in claim 5, wherein the tang has a slot between the pins allowing them to be sprung together for fitting into the apertures.

7. An ocular device as claimed in any preceding claim, the rear edges of the extensions are angled with respect to the hinge axis, preferably forming points with the top of the extensions.

8. An ocular device as claimed in any preceding claim, wherein the hinge axis is inclined for and aft, with the upper pin being behind the lower pin, in order to cause distal angled ends of the side pieces to incline forwards when closed to the front piece.

9. An ocular device as claimed in claim 8, wherein the hinge inclination is of the order of 5°.

10. An ocular device as claimed in any preceding claim, wherein the hinge axis is inclined laterally, with the upper pin being outwards of the lower pin, in order to cause the side pieces to cross when folded together.

11. An ocular device as claimed in any preceding claim, wherein the front piece has a central portion with a regular cross-section, to which an adjustable nose piece is clipped.

12. An ocular device as claimed in any one of claims 1 to 10, including a nose piece integrally formed with the front piece.

13. An ocular device as claimed in claim 11 or claim 12; wherein the nose piece has a central stem and a dependent, forked nose abuttal.

14. An ocular device as claimed in any preceding claim, wherein the vision assistance elements are opaque eye shading elements extending forwards and slightly downwards.

15. An ocular device as claimed in claim 14, wherein at each vision assistance element, the front piece is arched to an arched transverse shape of the shading elements, the latter being clipped to the frame at opposite sides of their arches to provide them with their arched shape.

16. An ocular device as claimed in any preceding claim, wherein the shading elements are laminar, with integrally moulded ribs at the rear edge to provide comfortable abutment against the wearer's eyebrows.

17. An ocular device as claimed in any preceding claim, wherein the rear edges of the vision assistance elements are contoured to match the wearer's bone structure at the eyebrow.

18. An ocular device as claimed in any preceding claim, wherein the front piece has front and rear lips at either end of each arch for clipping engagement over the vision assistance elements, the vision assistance elements having lateral notches for engagement with the front piece at the lips, the lips being generally aligned with the ends of the arches.

19. An ocular device as claimed in claim 18, wherein the front piece lips provide the upper bounds of grooves in which the notched vision assistance elements engage.

20. An ocular device as claimed in any preceding claim, wherein the front piece and/or the side pieces are of acetal polymer.
